(19) United States
(12) Patent Application Publication
(10) Pub. No.: US 2014/0267414 A1
(43) Pub. Date: Sep. 18, 2014

(54) VIRTUAL BOOKSHELVES FOR DISPLAYING AND SHARING DIGITAL CONTENT

(71) Applicant: Google Inc., Mountain View, CA (US)

(72) Inventors: Richard M. Conlan, Mansfield, MA (US); Abraham Phelps Murray, Scituate, MA (US)

(73) Assignee: Google Inc., Mountain View, CA (US)

(21) Appl. No.: 14/136,983

(22) Filed: Dec. 20, 2013

Related U.S. Application Data
(60) Provisional application No. 61/779,915, filed on Mar. 13, 2013.

(51) Int. Cl. G06T 19/00

(52) U.S. Cl. CPC G06T 19/006
USPC 345/633

(57) ABSTRACT

A virtual bookshelf for displaying digital content items is generated. In operation, a virtual space that is to contain a virtual bookshelf is defined and the virtual bookshelf is generated based on dimensions of the virtual space. The virtual bookshelf is populated with digital content items. The virtual bookshelf and the digital content items are displayed using a display device.

### CROSS-REFERENCE TO RELATED APPLICATION

This application claims benefit of U.S. Provisional Application No. 61/779,915, filed on Mar. 13, 2013.

### BACKGROUND

1. Field of Disclosure

The disclosure generally relates to displaying digital content such as electronic books, and in particular to displaying such digital content in virtual bookshelves.

2. Background Information

Electronic books and other forms of digital content are growing increasingly popular. One benefit consuming content in a digital format is that it is easily transportable and can be accessed at a variety of locations. A user can use one electronic device, such a personal computer, to read digital content while at home, and use a different device, such as a mobile telephone, to read the same digital content while on the road.

However, the current user experience for consuming content in a digital format has some drawbacks. Specifically, users who purchase and/or consume digital content cannot organize and interact with the content in a manner that resembles their interactions with a physical bookshelf. The lack of a “bookshelf” experience has negatively impacted the way users interact with digital content.

### SUMMARY

The above and other issues are addressed by a method, computer, and computer-readable storage medium for generating a virtual bookshelf for displaying digital content items. A virtual space is defined that is to contain a virtual bookshelf relative to a physical location. The virtual bookshelf is then generated based on dimensions of the virtual space and populated with digital content items. The virtual bookshelf and the digital content items are displayed on a display device.

An embodiment of the computer comprises a non-transitory computer-readable storage medium storing computer program modules executable to perform steps. The steps generate a virtual bookshelf for displaying digital content items. A virtual space is defined that is to contain a virtual bookshelf relative to a physical location. The virtual bookshelf is then generated based on dimensions of the virtual space and populated with digital content items. The virtual bookshelf and the digital content items are displayed on a display device.

An embodiment of the medium stores computer program modules for generating a virtual bookshelf. The computer program modules are executable to perform steps. The steps generate a virtual bookshelf for displaying digital content items. A virtual space is defined that is to contain a virtual bookshelf relative to a physical location. The virtual bookshelf is then generated based on dimensions of the virtual space and populated with digital content items. The virtual bookshelf and the digital content items are displayed on a display device.

### BRIEF DESCRIPTION OF THE DRAWINGS

FIG. 1 is a high-level block diagram of a computing environment according to one embodiment.

FIG. 2 is a high-level block diagram illustrating a typical computer for use as a bookshelf server or a client device.

FIG. 3 is a high-level block diagram illustrating a detailed view of the virtual bookshelf management module and other entities according to one embodiment.

FIG. 4 is a high-level block diagram illustrating a detailed view of the virtual bookshelf client module of the client device according to one embodiment.

FIG. 5 is a flow diagram illustrating steps performed by the client module for generating a virtual bookshelf according to one embodiment.

FIG. 6 is a flow diagram illustrating steps performed by the client module for retrieving a pre-generated virtual bookshelf for display to a user according to one embodiment.

### DETAILED DESCRIPTION

FIG. 1 is a block diagram illustrating a computing environment 100 for generating and displaying virtual bookshelves according to one embodiment. The environment 100 includes a virtual bookshelf server 104 (the “bookshelf server 104”) and a client device 106 communicatively coupled to each other through a network 102. Although only one bookshelf server 104 and client device 106 are illustrated, the computing environment may include multiple instances of each entity. Moreover, some of the functions ascribed to the bookshelf server 104 may be performed by the client device 106 and vice versa. Other entities may also be coupled to the network 102.

The client device 106 is a computing device with a processor and a memory used by one or more users to view and consume digital content. The client device 106 may be, for example, a mobile phone, a desktop, a laptop, a tablet computer, an augmented reality (AR) device or a dedicated digital content consumption device. The client device 106 may execute one or more applications that support displaying and consuming digital content.

In the illustrated embodiment, the client device 106 includes a virtual bookshelf client module 112 (“the client module 112”). The client module 112 generates virtual bookshelves and displays such virtual bookshelves to users. A virtual bookshelf is a visual representation of a bookshelf and includes a collection of digital content items that may be consumed and/or shared by users of the virtual bookshelf. A virtual bookshelf may be associated with a specific physical location such that the bookshelf may be automatically displayed by the client device 106 when the client device 106 is subsequently in the vicinity of the location.

When generating a virtual bookshelf, the client module 112 defines a virtual space that will contain the virtual bookshelf. In one embodiment, the virtual space occupies a portion of free space within a physical space, such as a wall within a room of a house, and has dimensions that are determined based on the free space. The free space may be selected by a user via a user interface provided by the client module 112 or may be automatically determined based on a video input or a sensor input. In an alternate embodiment, the virtual space is a user-defined construct that specifies the dimensions of the space that is to contain the virtual bookshelf.

The client module 112 generates a virtual bookshelf based on the dimensions of the virtual space. The virtual bookshelf is defined by a set of attributes, where each attribute controls a different aspect of the virtual bookshelf. Examples of such attributes include, but are not limited to, size, color, number of shelves, etc. In one embodiment, the client module 112 enables the user to modify one or more attributes defining the virtual bookshelf via a user interface.

Once generated, the client module 112 causes the virtual bookshelf to be displayed on a display provided by or communicatively coupled to the client device 106. Further, the client module 112 also causes a collection of digital content items, such as electronic books, to be displayed within the virtual bookshelf (“the digital content associated with the virtual bookshelf”). The client module 112 then enables a user to interact with the digital content items displayed within the virtual bookshelf. In one embodiment, the client module 112 causes the virtual bookshelf and the digital content within the virtual bookshelf to be overlaid into the user's vision via an AR-enabled display device.

In addition, the client module 112 operates in conjunction with the bookshelf server 104 to persist the set of attributes defining a virtual bookshelf and the virtual space that contains the virtual bookshelf. Consequently, previously-generated virtual bookshelves can be retrieved by the client module 112 for display. In one embodiment, the client module automatically displays a generated virtual bookshelf when the client device 106 is in the vicinity of the physical location associated with virtual bookshelf. The client module 112 also enables a user to browse the virtual bookshelves that are accessible to the user, such as a virtual bookshelf shared with the user. While browsing, the user may select a virtual bookshelf for viewing, and the client module 112 then displays the virtual bookshelf.

The bookshelf server 104 is a computing device with a processor and a memory that communicates with the client device 106 via the network 102 to facilitate generating and displaying virtual bookshelves. Depending upon the embodiment, the bookshelf server 104 may be implemented as cloud-based service distributed across multiple physical servers.

In the illustrated embodiment, the bookshelf server 104 includes a virtual bookshelf management module 108 (the “management module 108”) and a storage repository 110. The management module 108 interfaces with the client module 112 to enable the aforementioned functionality of the client module 112. In operation, the management module 108 stores a set of attributes that defines a virtual bookshelf and the definition of the virtual space containing the virtual bookshelf in the storage repository 110 in response to receiving those attributes from the client module 112. In addition, the management module 108 stores in the storage repository 110 the particular digital content item that a user has interacted with via the virtual bookshelf. Finally, the management module 108 retrieves attributes related to a virtual bookshelf for transmission to the client module 112 in response to a request received from the client module 112. Such functionality enables the client module 112 to display a previously-generated virtual bookshelf when appropriate.

The management module 108 also determines the digital content items available to populate a particular virtual bookshelf. In operation, the management module 108 receives a request from the client module 112 for populating a newly-generated virtual bookshelf with digital content items. The management module 108 then determines the digital content items based on a collection of information, including, but not limited to, user information and the set of attributes defining the virtual bookshelf. More specifically, the management module 108 may determine the digital content items based on user profiles associated with the users that are to interact with the virtual bookshelf. A user profile may include the interests of a user and a digital content purchase history associated with the user. The management module 108 may also determine the digital content items based on the set of attributes defining the virtual bookshelves, such as the number and sizes of the shelves. In one embodiment, the collection of information used by the management module to determine the digital content items is stored in the storage repository 110.

The network 102 represents the communication pathways between the bookshelf server 104, client device 112, and any other entities on the network. In one embodiment, the network 102 is the Internet and uses standard communications technologies and/or protocols. Thus, the network 102 can include links using technologies such as Ethernet, 802.11, worldwide interoperability for microwave access (WiMAX), 3G, digital subscriber line (DSL), asynchronous transfer mode (ATM), InfiniBand, PCI Express Advanced Switching, etc. Similarly, the networking protocols used on the network 102 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 102 can be represented using technologies and/or formats including the hypertext markup language (HTML), the extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc. In other embodiments, the entities use custom and/or dedicated data communications technologies instead of, or in addition to, the ones described above.

FIG. 2 is a high-level block diagram illustrating a typical computer 200 for use as a security server 110 or client 112. Illustrated are a processor 202 coupled to a chipset 204. Also coupled to the chipset 204 are a memory 206, a storage device 208, a keyboard 210, a graphics adapter 212, a pointing device 214, and a network adapter 216. A display 218 is coupled to the graphics adapter 212. In one embodiment, the functionality of the chipset 204 is provided by a memory controller hub 220 and an I/O controller hub 222. In another embodiment, the memory 206 is coupled directly to the processor 202 instead of the chipset 204.

The storage device 208 is a non-transitory computer-readable storage medium, such as a hard drive, compact disk read-only memory (CD-ROM), DVD, or a solid-state memory device. The memory 206 holds instructions and data used by the processor 202. The pointing device 214 is a mouse, track ball, or other type of pointing device, and is used in combination with the keyboard 210 to input data into the computer system 200. The graphics adapter 212 displays images and other information on the display 218. The network adapter 216 couples the computer system 200 to the network 116.

As is known in the art, a computer 200 can have different and/or other components than those shown in FIG. 2. In addition, the computer 200 can lack certain illustrated components. In one embodiment, a computer 200 acting as a virtual bookshelf server 104 is formed of multiple blade computers and lacks a keyboard 210, pointing device 214, graphics adapter 212, and/or display 218. Moreover, the storage device 208 can be local and/or remote from the computer 200 (such as embodied within a storage area network (SAN)).

This description uses the term “module” to refer to computer program logic for providing a specified functionality. A module can be implemented in hardware, firmware, and/or software. A module is typically stored on a computer-readable storage medium such as the storage device 208, loaded into the memory 206, and executed by the processor 202.

FIG. 3 is a high-level block diagram illustrating a detailed view of the virtual bookshelf management module 108 of the bookshelf server 104 and other entities according to one embodiment. As shown in FIG. 3, the management module 108 itself includes multiple modules. In some embodiments, the functions are distributed among these modules in a different manner than described herein.

A user data module 302 manages data associated with different users interacting with instances of the client module 112. The user data module 302 maintains data associated with each user as a user profile associated with a unique user identifier (ID). The user profiles are stored within the user profiles 312 portion of the storage repository 110. Examples of data stored in a user profile include a list of virtual bookshelves that are accessible to the user, a set of user preferences and a digital content purchase history for the user.

For a particular user operating a client device 106, the user data module 302 collects information to be included in a user profile in a variety of ways. The user data module 302 may periodically interact with the client module 112 to retrieve an audit trail of actions performed by the user. Such an audit trail may include a list of websites that the user accessed via the client device 106 and a list of digital content items that the user viewed or purchased via the client device 106. The user data module 302 then parses and analyzes the audit trail and stores the relevant information in the user profile.

The user data module 302 may also periodically poll third-party services to retrieve information related to the particular user, such as the user's interests and preferences related to genres of digital content items. Such third-party services may include social networking services to which the user subscribes or third-party content providers from which the user has previously purchased content. Finally, the user may manually provide certain information to the user data module 302. For example, the user may input via a user interface provided by the client module 112 her preferences related to both types of digital content items and the appearance and configuration of virtual bookshelves.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

A virtual bookshelf data module 304 (“the bookshelf data module 304”) manages data associated with virtual bookshelves generated by different instances of the client module 112. The bookshelf data module 304 stores data associated with each virtual bookshelf as a bookshelf profile associated with a unique bookshelf identifier (ID). The bookshelf profiles are stored within the bookshelf profiles 314 portion of the storage repository 110. Examples of data stored in a bookshelf profile include the set of attributes defining the virtual bookshelf and the virtual space that contains the virtual bookshelf, the list of users who can access the virtual bookshelf and the digital content items associated with the virtual bookshelf.

When a virtual bookshelf is first generated, the bookshelf data module 304 receives the set of attributes defining the virtual bookshelf and the virtual space that contains that virtual bookshelf from the client module 112. The bookshelf data module 304 then stores the received set of attributes in the storage repository as a bookshelf profile. The bookshelf profile is associated with a unique bookshelf ID that identifies the particular virtual bookshelf.

Once the virtual bookshelf is populated with digital content items, the bookshelf data module 304 updates the bookshelf profile to include the list of digital content items within the virtual bookshelf. In addition, for each digital content item in the list of digital content items, the bookshelf data module 304 stores in the bookshelf profile a set of states indicating information about the digital content item that is unique to the virtual bookshelf. For a particular digital content item, a “location” state in the set of states indicates the location within the virtual bookshelf where the digital content item was last placed. A “checked out” state indicates whether the digital content item was checked out and, if so, by which user. Further, an “amount viewed” state indicates how much of the digital content item has been viewed by a user. Other states not explicitly described here, such as the number of views of the digital content item, may be additionally captured in the set of states.

The bookshelf data module 304 also stores access control information related to the virtual bookshelf in the bookshelf profile. The access control information describes users' access rights with respect to the virtual bookshelf. More specifically, the user that created the virtual bookshelf may provide, via the client module 112, bookshelf access privileges to certain users, such that only those users are able to view and/or interact with the virtual bookshelf. Alternatively, the user that created the virtual bookshelf may designate, via the client module 112, the virtual bookshelf as a public bookshelf, such that any user of an instance of the client module 112 may view and interact with the virtual bookshelf. The bookshelf data module 304 stores these bookshelf level access control designations in the bookshelf profile.

In addition, users having access to the virtual bookshelf may designate, via the client module 112, access control privileges at the digital content level. The access control privileges for a particular digital content item describe users' access rights with respect to the digital content item. For example, a user may designate a particular digital content item within the virtual bookshelf as private, such that only that user is able to view and interact with the digital content item within virtual bookshelf. Alternatively, the user may designate a particular digital content item as public, such that any user who has access to the virtual bookshelf may view and interact with the digital content item. The bookshelf data module 304 stores these digital content level access control designations in the bookshelf profile.

The bookshelf data module 304 also receives requests from various instances of the client module 112 for retrieving information related to virtual bookshelves so that those bookshelves may be displayed to users. Such a request typically includes a bookshelf ID identifying the particular virtual bookshelf and a user ID identifying the user to whom the virtual bookshelf is to be displayed. Upon receiving the request, the bookshelf data module 304 retrieves the bookshelf profile associated with the bookshelf ID from the storage repository 110.

The bookshelf data module 304 then performs an access control check to determine, based on the bookshelf level access control information in the bookshelf profile, whether the user associated with the user ID can access the virtual bookshelf. If the user cannot access the virtual bookshelf, then the bookshelf data module 304 transmits an error message to the client module 112 indicating that the user does not have access privileges. If the user can access the virtual bookshelf, then the bookshelf data module 304 transmits the bookshelf profile to the client module 112. In an alternate embodiment, the bookshelf data module 304 does not determine whether the user can access the virtual bookshelf and, instead, directly transmits the bookshelf profile to the client module 112 in response to receiving the request. In such an embodiment, the client module 112 performs the access control check.

A content module 306 manages data associated with digital content items available for populating virtual bookshelves. In operation, the content module 306 periodically polls content servers 310 to determine whether new digital content items are available. A content server 310 may be a content publishing service or a content distribution service. If, in polling the content servers 310, the content module 306 determines that a new digital content item is available, the content module 306 retrieves data associated with the new digital content item from the content servers 310. Such data may include the title of the digital content item, the genre to which the digital content item belongs, content type, etc. The data may also include display characteristics that control how the digital content item is to be displayed. The content module 306 stores the data associated with the digital content item in the content data 316 portion of the storage repository 110.

The content module 306 receives requests from various instances of the client module 112 for retrieving data associated with digital content items. Such a request typically includes a unique ID identifying the particular digital content item. Upon receiving the request, the bookshelf data module 304 retrieves the data associated with the digital content item from the storage repository 110 and transmits the data to the client module 112. Again, the data associated with the digital content items includes descriptive data, such as the title of the digital content item, the genre to which the digital content item belongs, etc., and also display characteristics that control how the digital content item is to be displayed. The client module 112 displays the digital content items based on the data received from the content module 306.

The content module 306 also receives requests from various instances of the client module 112 for retrieving the content of the digital content items. More specifically, when a user wishes to consume a digital content item displayed by the client module 112, the client module 112 transmits a request to the content module 112 for the content of the digital content item. The content module 306, in response to receiving such a request, communicates with the content servers 310 to retrieve the content of the digital content item for transmission to the client module 112. In one embodiment, the content module 306 communicates with the content servers 310 to determine whether the user who wishes to consume the digital content item must first purchase the digital content item. If the user must first purchase the digital content item, then the content module 306 orchestrates the purchase of the digital content item from the content servers 310. The content of the purchased digital content item is then retrieved from the content servers 310 for transmission to the client module 112.

A bookshelf populating module 308 receives requests from various instances of the client module 112 for populating virtual bookshelves with digital content items. In response to a request for populating a particular virtual bookshelf, the bookshelf populating module 308 determines a list of digital content items to be displayed in the virtual bookshelf. The bookshelf populating module 308 transmits the list of digital content items to the client module 112 for display within the virtual bookshelf.

The bookshelf populating module 308 determines the list of digital content items based on the user profile(s) associated with the users who may access the virtual bookshelf as well as the set of attributes associated with the virtual bookshelf. For example, the bookshelf populating module 308 may analyze a user's purchase history or the list of digital content item previously consumed by the user to determine the list of digital items that should be included in the virtual bookshelf. Further, the bookshelf populating module 308 may analyze the set of attributes associated with the virtual bookshelf to determine the genre and the number of digital content items that should be displayed within the virtual bookshelf. The bookshelf populating module 308 transmits the list of digital content items to the client module 112 for display within the virtual bookshelf.

FIG. 4 is a high-level block diagram illustrating a detailed view of the virtual bookshelf client module 112 of the client device 106 according to one embodiment. As shown in FIG. 4, the client module 112 includes multiple modules. In some embodiments, the functions are distributed among these modules in a different manner than described herein.

A bookshelf definition module 402 generates a definition of a virtual space that will contain a virtual bookshelf. The bookshelf definition module 402 operates in one of two modes. In the first mode, the bookshelf definition module 402 receives a set of dimensions defined by a user of the bookshelf client module 112. The bookshelf definition module 402 may optionally receive user-specified coordinates of a particular physical location to be associated with the virtual bookshelf. The bookshelf definition module 402 then generates the virtual space based on the set of dimensions and associates the virtual space with any physical coordinates specified by the user.

In the second mode, the bookshelf definition module 402 identifies free space within a physical space and generates the definition of a virtual space based on the free space. In one embodiment, the bookshelf definition module 402 detects the free space by performing image analysis operations on a video or image of the physical space. The video or image may be input via a camera device communicatively coupled to or included in the client device 106. Alternatively, the video or image may be selected by a user of the bookshelf client module 112 from a catalogue of videos or images available to the user. In another embodiment, the bookshelf module 402 receives a selection of the free space within the physical space as an input from the user of the bookshelf client module 112. In such an embodiment, the bookshelf definition module 402 may present an image of the physical space to the user and, in response, receive a user input indicating a portion of the image as the free space that should contain the virtual bookshelf.

Once the free space is identified, the bookshelf definition module 402 computes the dimensions of the free space relative to the dimensions of the entire physical space. The bookshelf definition module 402 also identifies by analyzing the video or image of the physical space one or more unique markers that may be used to identify the free space in the future. Such unique markers include objects and/or visually discernible marks and colors in or around the free space. The bookshelf definition module 402 then generates a virtual space definition that specifies the dimensions of the free space and identifies the one or more unique markers. In one embodiment, the bookshelf definition module 402 also identifies the coordinates describing the physical location of the free space via a location sensor included in the client device 106, and the definition of the virtual space specifies the identified coordinates.

The bookshelf definition module 402 transmits the virtual space definition to a bookshelf generation module 404 for further processing. The bookshelf generation module 404 generates a virtual bookshelf based on the virtual space definition. The virtual bookshelf is defined by a set of attributes, where each attribute controls a different aspect of the virtual bookshelf. Examples of such attributes include, but are not limited to, size, color, number of shelves, etc.

For each attribute in the set of attributes, the bookshelf generation module 404 determines the value of the attribute based on the virtual space definition, a user profile associated with the user of the bookshelf client module 112 and/or other user provided inputs. For example, the bookshelf generation module 404 determines the size of the virtual bookshelf to equivalent to or smaller than the dimensions specified by the virtual space definition. The aesthetic attributes, such as the color and texture attributes, may be determined based on user preferences specified in the user profile retrieved from the user data module 302 described above. Alternatively, the user of the bookshelf client module 112 may specify the values of one or more attributes via a user interface at the time of the virtual bookshelf generation.

The bookshelf generation module 404 transmits the set of attributes to the bookshelf data module 304 for storage in the storage repository 110. The bookshelf generation module 404 also transmits a request to the bookshelf populating module 308 for populating the virtual bookshelf with digital content items. As discussed above, the bookshelf populating module 308 identifies a list of digital content items to be displayed within the virtual bookshelf based on several considerations including the user's purchase history and the set of attributes associated with the virtual bookshelf. The bookshelf populating module 308 updates the bookshelf profile to include the list of digital content items.

A display module 406 causes virtual bookshelves to be displayed on a display device within or communicatively coupled to the client device 106. The display module 406 identifies the particular virtual bookshelf to be displayed automatically or via user selection. For automatic identification, the display module 406 automatically determines that the client device 106 is in the vicinity of the physical space associated with a particular virtual bookshelf, i.e., the physical space based on which the virtual space containing the bookshelf was defined. The display module 406 makes such detection by analyzing a video or an image of the physical space and identifying markers in the physical space that match the unique markers included in the virtual space definition. Alternatively, the display module 406 makes such detection by matching coordinates specified by a location sensor within the client device 106 with coordinates included in the virtual space definition of the virtual bookshelf.

The display module 406 then requests the bookshelf profile associated with the particular virtual bookshelf from the virtual bookshelf data module 304. The display module 406 also requests from the content module 306 data associated with each digital content item in the list of digital content items specified by the bookshelf profile. Based on the set of attributes included in the bookshelf profile and the data associated with the list of digital content items, the display module 406 generates a visual representation of the virtual bookshelf including the digital content items. In one embodiment, where the client device 112 is an AR enabled device worn by a user, the display module 406 causes the virtual representation of the virtual bookshelf to be overlaid into the user's vision.

The display module 406 may also determine via a bookshelf browsing module 408 that the user has selected a particular virtual bookshelf for display. The bookshelf browsing module 408 allows the user to browse through a catalogue of previously-generated virtual bookshelves. In operation, the bookshelf browsing module 408 transmits a request to the virtual bookshelf data module 304 for a list of bookshelf profiles associated with virtual bookshelves that are accessible to the user. The bookshelf browsing module 408 then allows the user to view information regarding each of the bookshelves and select bookshelves for display. If the user selects a particular virtual bookshelf for display, the bookshelf browsing module 408 transmits the bookshelf ID of the selected bookshelf to the display module 406. The display module 406 then causes the virtual bookshelf and the included digital content items to be displayed in the same manner as described above.

A bookshelf interaction module 410 allows a user to interact with a displayed visual representation of the virtual bookshelf. The user, via the bookshelf interaction module 410, may change attributes of the virtual bookshelf, share or stop sharing the virtual bookshelf with specific users, set or modify bookshelf-level access control and subscribe to or unsubscribe from the virtual bookshelf. In addition, the user may, via the bookshelf interaction module 410, interact with the individual digital content items displayed in the virtual bookshelf. Specifically, the user may view, purchase and check in/out digital content items displayed in the virtual bookshelf. Further, the user may comment on specific portions of a digital content item via the bookshelf interaction module 410. The bookshelf module 410 then transmits the comments to the virtual bookshelf data module 304 for storage in the storage repository 110.

The bookshelf interaction module 410 may receive input from users via gestures, keystrokes on a keyboard or touch input. In the embodiment where the visual representation of the virtual bookshelf is overlaid into the user's vision, the bookshelf interaction module 410 allows the user to interact with the virtual bookshelf via hand gestures. For example, the bookshelf interaction module 410 detects a tapping gesture performed by the user and correlates the tapping gesture to an individual digital content item displayed in the visual representation of the virtual bookshelf. The bookshelf interaction module 410 then displays the internal contents of the digital content item as retrieved from the management module 108.

FIG. 5 is a flow diagram illustrating steps performed by the client module 112 for generating a virtual bookshelf based on a virtual space definition according to one embodiment. Other embodiments can perform different and/or additional steps. Moreover, other embodiments can perform the steps in different orders. Further, some or all of the steps can be performed by entities other than the client module 112.

At step 502, the client module 112 generates a definition of a virtual space that will contain the virtual bookshelf. At step 504, the client module 112 generates a virtual bookshelf based on the virtual space definition. The virtual bookshelf is defined by a set of attributes, where each attribute controls a different aspect of the virtual bookshelf. At step 506, the client module 112 identifies a list of digital content items to be displayed within the virtual bookshelf. At step 508, the client module 112 displays the virtual bookshelf including the digital content items identified at step 506. At step 510, the client module 112 receives a user interaction with the virtual bookshelf. User interactions include, but are not limited to, modifying one or more attributes of the virtual bookshelf, interacting with one or more digital content items displayed in the virtual bookshelf or sharing the virtual bookshelf with other users. At step 512, the client module 112 updates attributes of the virtual bookshelf or state associated with digital content items in the virtual bookshelf based on the user interaction.

FIG. 6 is a flow diagram illustrating steps performed by the client module 112 for retrieving a pre-generated virtual bookshelf for display to a user according to one embodiment. Other embodiments can perform different and/or additional steps. Moreover, other embodiments can perform the steps in different orders. Further, some or all of the steps can be performed by entities other than the client module 112.

At step 602, the client module 112 determines that the client device 106 is in the vicinity of the physical space associated with a particular virtual bookshelf, i.e., the physical space based on which the virtual space containing the bookshelf was defined. At step 604, the client module 112 retrieves from the virtual bookshelf data module 304 the bookshelf profile associated with the particular virtual bookshelf. At step 606, the client module 112 generates a visual representation of the virtual bookshelf based on the virtual space definition and the set of attributes included in the bookshelf profile. At step 608, the client module 112 retrieves from the content module 306 data associated with each digital content item in the list of digital content items specified by the bookshelf profile. At step 610, the client module 112 generates a visual representation of each digital content item based on the associated data and displays the visual representation of the digital content item within the virtual bookshelf.

The above description is included to illustrate the operation of certain embodiments and is not meant to limit the scope of the invention. The scope of the invention is to be limited only by the following claims. From the above discussion, many variations will be apparent to one skilled in the relevant art that would yet be encompassed by the spirit and scope of the invention.

What is claimed is:

1. A computer-implemented method of generating a virtual bookshelf for displaying digital content items, comprising:
defining a virtual space that is to contain a virtual bookshelf relative to a physical location;
generating the virtual bookshelf based on dimensions of the virtual space;
populating the virtual bookshelf with one or more digital content items; and
displaying the virtual bookshelf and the one or more digital content items using a display device.

2. The method of claim 1, wherein defining the virtual space comprises:
analyzing an image of the physical location to identify free space in the physical location that is to be occupied by the virtual bookshelf; and
defining the virtual space based on dimensions of the free space.

3. The method of claim 1, wherein displaying the virtual bookshelf and the one or more digital content items comprises overlaying a visual representation of the virtual bookshelf and the one or more digital content items onto an image of the physical location.

4. The method of claim 1, wherein defining the virtual space comprises:
analyzing an image of the physical location to identify one or more markers in the physical location that uniquely identify free space in the physical location; and
defining the virtual space based on the one or more markers.

5. The method of claim 4, wherein displaying the virtual bookshelf and the one or more digital content items comprises:
analyzing a second image of a current physical location of a computing device coupled to the display device;
determining that the one or more markers are present in the second image;
defining a second virtual space for the second image based on the one or more markers present in the second image;
generating a visual representation of the virtual bookshelf based on dimensions of the second virtual space; and
displaying the visual representation using the display device, the visual representation overlaying a visual representation of the virtual bookshelf and the one or more digital content items onto the second image.

6. The method of claim 1, wherein a user of the virtual bookshelf is associated with a set of digital content items, and populating the virtual bookshelf comprises populating the virtual bookshelf with at least one digital content item included in the set of digital content items.

7. The method of claim 1, wherein displaying the virtual bookshelf comprises:
receiving a user input from a user indicating a selection of the virtual bookshelf;
analyzing access control information associated with the virtual bookshelf to determine that the user has privileges to view the virtual bookshelf; and
displaying the virtual bookshelf and the one or more digital content items responsive to determining that the user has privileges to view the virtual bookshelf.

8. The method of claim 1, wherein displaying the virtual bookshelf comprises:
receiving a user input from a user indicating a selection of the virtual bookshelf; and
determining whether a second user has granted privileges to view the virtual bookshelf to the user.

9. A system for generating a virtual bookshelf for displaying digital content items, comprising:
a processor for executing computer program instructions; and
a non-transitory computer-readable storage medium storing computer program instructions executable to perform steps comprising:
defining a virtual space that is to contain a virtual bookshelf relative to a physical location,
generating the virtual bookshelf based on dimensions of the virtual space,
populating the virtual bookshelf with one or more digital content items, and
displaying the virtual bookshelf and the one or more digital content items using a display device.

10. The system of claim 9, wherein defining the virtual space comprises:
analyzing an image of the physical location to identify free space in the physical location that is to be occupied by the virtual bookshelf; and
defining the virtual space based on dimensions of the free space.

11. The system of claim 9, wherein displaying the virtual bookshelf and the one or more digital content items comprises overlaying a visual representation of the virtual bookshelf and the one or more digital content items onto an image of the physical location.

12. The system of claim 9, wherein defining the virtual space comprises:
analyzing an image of the physical location to identify one or more markers in the physical location that uniquely identify free space in the physical location; and
defining the virtual space based on the one or more markers.

13. The system of claim 12, wherein displaying the virtual bookshelf and the one or more digital content items comprises:
analyzing a second image of a current physical location of a computing device coupled to the display device;
determining that the one or more markers are present in the second image;
defining a second virtual space for the second image based on the one or more markers present in the second image;
generating a visual representation of the virtual bookshelf based on dimensions of the second virtual space; and
displaying the visual representation using the display device, the visual representation overlaying a visual representation of the virtual bookshelf and the one or more digital content items onto the second image.

14. The system of claim 9, wherein a user of the virtual bookshelf is associated with a set of digital content items, and populating the virtual bookshelf comprises populating the virtual bookshelf with at least one digital content item included in the set of digital content items.

15. The system of claim 9, wherein displaying the virtual bookshelf comprises:
receiving a user input from a user indicating a selection of the virtual bookshelf;
analyzing access control information associated with the virtual bookshelf to determine that the user has privileges to view the virtual bookshelf; and
displaying the virtual bookshelf and the one or more digital content items responsive to determining that the user has privileges to view the virtual bookshelf.

16. The system of claim 9, wherein displaying the virtual bookshelf comprises:
receiving a user input from a user indicating a selection of the virtual bookshelf; and
determining whether a second user has granted privileges to view the virtual bookshelf to the user.

17. A non-transitory computer-readable storage medium storing executable computer program instructions for generating a virtual bookshelf for displaying digital content items, the computer program instructions executable to perform steps comprising:
defining a virtual space that is to contain a virtual bookshelf relative to a physical location;
generating the virtual bookshelf based on dimensions of the virtual space;
populating the virtual bookshelf with one or more digital content items; and
displaying the virtual bookshelf and the one or more digital content items using a display device.

18. The computer-readable storage medium of claim 17, wherein defining the virtual space comprises:
analyzing an image of the physical location to identify free space in the physical location that is to be occupied by the virtual bookshelf; and
defining the virtual space based on dimensions of the free space.

19. The computer-readable storage medium of claim 17, wherein displaying the virtual bookshelf and the one or more digital content items comprises overlaying a visual representation of the virtual bookshelf and the one or more digital content items onto an image of the physical location.

20. The computer-readable storage medium of claim 17, wherein defining the virtual space comprises:
analyzing an image of the physical location to identify one or more markers in the physical location that uniquely identify free space in the physical location; and
defining the virtual space based on the one or more markers.
